(19) United States
(12) Patent Application Publication
(10) Pub. No.: US 2017/0061520 A1
(43) Pub. Date: Mar. 2, 2017

(54) METHOD AND SYSTEM FOR AUTOMATIC ADVERTISEMENT RECOMMENDATION OF PRODUCTS

(71) Applicants: LAKSHYA JAIN, LOS ALTOS, CA (US); PRIYA BISARYA, SAN DIEGO, CA (US)

(72) Inventors: LAKSHYA JAIN, LOS ALTOS, CA (US); PRIYA BISARYA, SAN DIEGO, CA (US)

(21) Appl. No.: 14/835,717

(22) Filed: Aug. 26, 2015

(51) Int. Cl. G06Q 30/06; G06Q 30/02

(52) U.S. Cl. CPC G06Q 30/0631; G06Q 30/0261

(57) ABSTRACT

The present disclosure provides a method and system for enabling automatic advertisement recommendation of one or more products to corresponding one or more users. The method includes receiving one or more attributes of a first set of attributes of the one or more products corresponding to the one or more users from a first pre-defined database, mapping the one or more received attributes from the first set of attributes with one or more attributes of a second set of attributes corresponding to the one or more users stored in a third party database, integrating the one or more mapped attributes with one or more attributes of a third set of attributes based on pain profiles and previously recommended one or more products and extracting a probable group of users from the one or more users.

### TECHNICAL FIELD

The present invention relates to the field of advertising and, in particular, relates to automatic advertisement recommendation of one or more products to one or more users.

### BACKGROUND

In the past few years, advertising industry has grown rapidly. The advertising is a form of marketing communication that encourages, persuades or manipulates an audience. Nowadays, advertisement of products is widely popular, particularly advertisements of medical products.

A huge population is suffering from a variety of medical conditions. Consumers are in constant need of medical products for betterment of their health. The medical products may include but not be limited to any drug, ointments, pain relieving gels and the like. Most traditional way of advertising the medical products is direct marketing of pharmaceuticals to physicians in their office practices. However, the direct marketing of pharmaceuticals to the physicians is now being replaced by direct-to-consumer pharmaceutical advertising. The medical products are now advertised to a large audience through e-mail, messaging, online advertising and the like.

In the present scenario, the advertising of medical products involves broadcasting the advertisements to consumers. However, the consumer receiving the advertisements may not be in need of the product advertised and gets annoyed due to frequently received advertisements. For example, an individual may receive an advertisement of a medical cream for treating acne; however there is a possibility that the individual may not be suffering from the acne. Moreover, the consumers experiencing a medical predicament receive imprecise advertisements or drug prescriptions. The current methods and systems do not provide effective targeting of the advertisements to the consumers. Furthermore, the present methods and systems do not provide product advertising companies a provision of advertising the medical products to a specific group of consumers. Moreover, the ineffective targeting of the consumers results in wastage of time, money and other resources invested by the product advertising companies. Furthermore, the current advertising methods are not effective enough to generate large revenues.

In the light of the above stated discussion, there is a need for a method and system that overcomes the above stated disadvantages. In addition, the method and system should focus on targeting specific consumers and provide useful advertisements of the products to the consumers.

### SUMMARY

In an aspect of the present disclosure, a computer-implemented method for enabling automatic advertisement recommendation of one or more products to corresponding one or more users is provided. The computer-implemented method includes receiving with a processor, one or more attributes of a first set of attributes of the one or more products corresponding to the one or more users from a first pre-defined database of one or more product based companies; mapping, with the processor, the one or more received attributes from the first set of attributes with one or more attributes of a second set of attributes corresponding to the one or more users stored in a third party database; integrating, with the processor, the one or more mapped attributes with one or more attributes from a third set of attributes corresponding to pain profiles and previously recommended one or more products stored in a second pre-defined database and extracting, with the processor, a probable group of users from the one or more users. The probable group of users is extracted based on an ID of each of the one or more users and each of the ID is generated based on the integrating.

In an embodiment of the present disclosure, the computer-implemented method further includes transmitting, with the processor, each of the ID to the one or more product based companies. In another embodiment of the present disclosure, the computer-implemented method further includes recommending, with the processor, one or more advertisements of each of the one or more products to each of the ID corresponding to each user of the probable group of users.

In an embodiment of the present disclosure, the first set of attributes includes at least one of age, gender, pain profile and pain relieving area.

In an embodiment of the present disclosure, the third party database includes databases of at least one of advertising agencies, third party advertising exchange, online publishers, sponsors, social networking platform, and search engines.

In an embodiment of the present disclosure, the second set of attributes includes at least one of name, age, gender and address.

In an embodiment of the present disclosure, the third set of attributes include at least one of name, age, gender, the pain profiles and the previously recommended one or more products.

In another aspect of the present disclosure, a computer system is provided. The computer system includes a non-transitory computer readable medium storing a computer readable program; the computer readable program when executed on a computer causes the computer to perform steps. The steps include receiving one or more attributes of a first set of attributes of one or more products corresponding to one or more users from a first pre-defined database of one or more product based companies, mapping the one or more received attributes from the first set of attributes with one or more attributes of a second set of attributes corresponding to the one or more users stored in a third party database, integrating the one or more mapped attributes with one or more attributes from a third set of attributes corresponding to pain profiles and previously recommended one or more products stored in a second pre-defined database and extracting a probable group of users from the one or more users. The probable group of users is extracted based on an ID of each of the one or more users and each of the ID is generated based on the integrating.

In an embodiment of the present disclosure, the computer readable program when executed on the computer causes the computer to perform a further step of transmitting each of the ID to the one or more product based companies. In another embodiment of the present disclosure, the computer readable program when executed on the computer causes the computer to perform a further step of recommending one or more advertisements of each of the one or more products to each of the ID corresponding to each user of the probable group of users.

In an embodiment of the present disclosure, the first set of attributes include at least one of age, gender, pain profile and pain relieving area.

In an embodiment of the present disclosure, the third party database include databases of at least one of advertising agencies, third party advertising exchange, online publishers, sponsors, social networking platform, and search engines.

In an embodiment of the present disclosure, the third set of attributes include at least one of name, age, gender, the pain profiles and the previously recommended one or more products.

In yet another aspect of the present disclosure, a system for enabling automatic advertisement recommendation of one or more products to corresponding one or more users is provided. The system includes a receiving module in a processor, the receiving module is configured to receive one or more attributes of a first set of attributes of the one or more products corresponding to the one or more users from a first pre-defined database of one or more product based companies; a mapping module in the processor, the mapping module is configured to map the one or more received attributes from the first set of attributes with one or more attributes of a second set of attributes corresponding to the one or more users stored in a third party database; an integrator engine in the processor, the integrator engine is configured to integrate the one or more mapped attributes with one or more attributes from a third set of attributes corresponding to pain profiles and previously recommended one or more products stored in a second pre-defined database and an extraction module in the processor, the extraction module is configured to extract a probable group of users from the one or more users.

In an embodiment of the present disclosure, the system further includes a generating module in the processor; the generation module is configured to generate an ID for each user of the probable group of users. In another embodiment of the present disclosure, the system further includes a transmission module in the processor, the transmission module is configured to transmit each of the ID to the one or more product based companies. In yet another embodiment of the present disclosure, the system further includes a recommendation engine in the processor, the recommendation engine is configured to recommend one or more advertisements of the one or more products to each of the corresponding ID.

In an embodiment of the present disclosure, the first set of attributes include at least one of age, gender, pain profile and pain relieving area.

In an embodiment of the present disclosure, the third party database includes databases of at least one of advertising agencies, third party advertising exchange, online publishers, sponsors, social networking platform, and search engines.

In an embodiment of the present disclosure, the second set of attributes includes at least one of name, age, gender and address.

In an embodiment of the present disclosure, the third set of attributes include at least one of name, age, gender, the pain profiles and the previously recommended one or more products.

### BRIEF DESCRIPTION OF THE FIGURES

Having thus described the disclosure in general terms, reference will now be made to the accompanying drawings, which are not necessarily drawn to scale, and wherein:

FIG. 1 illustrates a system for enabling automatic advertisement recommendation of one or more products, in accordance with various embodiments of the present disclosure;

FIG. 2 illustrates a system for generating pain profiles of one or more users, in accordance with various embodiments of the present disclosure;

FIG. 3 illustrates a block diagram of a communication device, in accordance with various embodiments of the present disclosure; and

FIG. 4 illustrates a flowchart for enabling the automatic advertisement recommendation of the one or more products, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

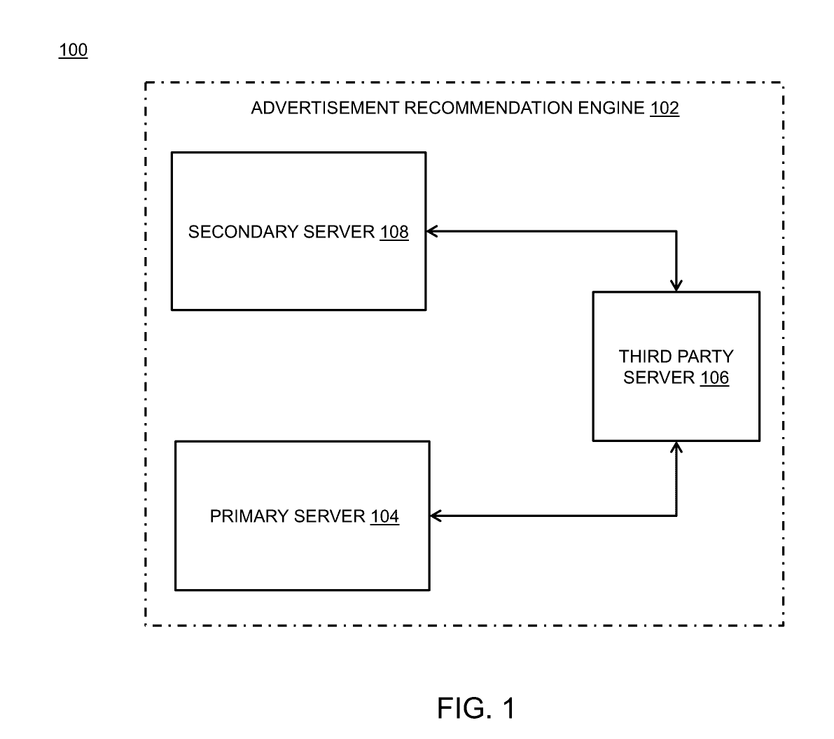

FIG. 1 illustrates a system 100 for enabling automatic advertisement recommendation of one or more products, in accordance with various embodiments of the present disclosure. The system 100 includes an advertisement recommendation engine 102. The advertisement recommendation engine 102 shows an interaction between a primary server 104, a third party server 106 and a secondary server 108 for providing the automatic advertisement recommendation of the one or more products to corresponding one or more users. The primary server 104 is a server associated with a product based company. Examples of the product based company include Pfizer, Sanofi, GlaxoSmithKline and the like. The one or more products may include but not be limited to antipyretics, analgesics, antibiotics, antiseptics or any other ointment/drug known in the art which is capable of relieving pain of the one or more users. Further, the primary server 104 includes a first pre-defined database that stores a first set of attributes of the one or more products corresponding to the one or more users. The first set of attributes includes age group for which the corresponding one or more products are made, gender to which the corresponding one or more products are suitable, pain relieving area or any other attribute for which the corresponding product is made.

The primary server 104 interacts with the third party server 106. The third party server 106 includes a third party database that stores a second set of attributes corresponding to the one or more users. The second set of attributes includes but may not be limited to name, age, gender, address and contact number. In an embodiment of the present disclosure, the third party database stores the second set of attributes of the one or more users from various online platforms. Examples of the online platforms may include but not be limited to social networking websites (for example, facebook, yahoo and the like), e-commerce websites (for example, jabong, flipkart and the like) and search engines (google, bing and the like).

The advertisement recommendation engine 102 maps one or more attributes of the first set of attributes with one or more attributes of the second set of attributes. Furthermore, the third party server 106 interacts with the secondary server 108. The secondary server 108 includes a second pre-defined database that stores a third set of attributes. The third set of attributes include but may not be limited to name, age, gender, pain profiles and previously recommended one or more products.

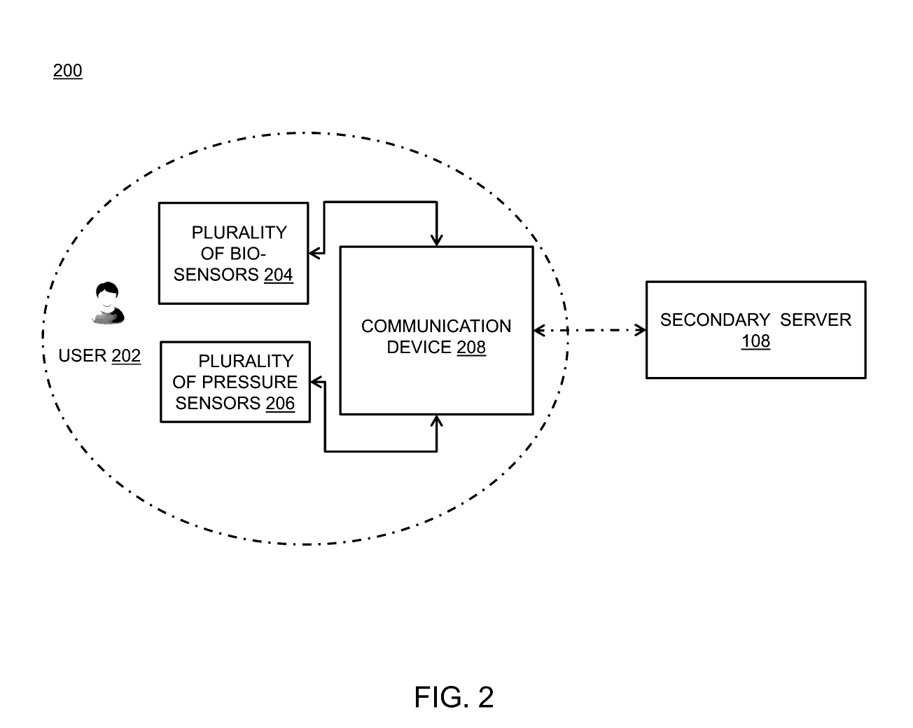

The secondary server 108 is a server associated with a health care institution. The health care institution provides health care services including provision of inpatient and outpatient care, diagnostic or therapeutic services, laboratory services, medicinal drugs, nursing care, assisted living, elderly care and the like. Examples of the health care institution include general hospitals, convalescent hospitals, family health centers, community mental health centers and the like. Furthermore, the health care institution provides health care facilities to the one or more users for monitoring of pain. In an embodiment of the present disclosure, the one or more users may be a healthy individual or a patient suffering from pain. In addition, the one or more users receive treatment based on the pain experienced by each of the one or more users (as exemplarily described in detailed description of FIG. 2).

The advertisement recommendation engine 102 integrates the one or more mapped attributes of the second set of attributes with one or more attributes of the third set of attributes based on the pain profiles and the previously recommended one or more products for treating the corresponding one or more users. Furthermore, the advertisement recommendation engine 102 extracts a probable group of users of the one or more users based on the integration of the one or more mapped attributes of the second set of attributes with the one or more attributes of the third set of attributes. In addition, the advertisement recommendation engine 102 generates an ID for each of one or more users of the extracted probable group of users.

In an embodiment of the present disclosure, the primary server 104 interacts with the third party server 106 through a communication network. Further, the third party server 106 interacts with the secondary server 108 through the communication network. The communications network provides a medium for transfer of information between the two servers. Example of the communication network may include but not be limited to local area network, metropolitan area network, wide area network, virtual private network, global area network, home area network or any other network capable of providing the communication between the servers. The medium for communication between the servers may be infrared, microwave, radio frequency (RF) and the like.

For example, a product X is provided by a company Y for the category of users of an age group of 25-35 suffering from knee pain. The advertisement recommendation engine 102 maps these attributes with the attributes stored in the third party database. Further, the advertisement recommendation engine 102 integrates these mapped attributes with the attributes stored in the second pre-defined database to extract a probable group of users Z. The advertisement recommendation engine 102 generates an ID for a user Z1, a user Z2 and a user Z3 of the probable group of users Z. The advertisement recommendation engine 102 provides the IDs to the company Y for recommending the advertisement of the product X to the user Z1, the user Z2 and the user Z3.

It may be noted that in FIG. 1, the primary server 104 is associated with the product based company; however, those skilled in the art would appreciate that there may be more servers associated with more than one product based company. It may also be noted that in FIG. 1, the secondary server 108 is associated with the health care institution; however, those skilled in the art would appreciate that there may be more servers associated with more than one health care institution.

FIG. 2 illustrates a system 200 for generating pain profiles of the one or more users, in accordance with various embodiments of the present disclosure. It may be noted that to explain the system elements of the FIG. 2, references will be made to the system elements of the FIG. 1. The system 200 includes a plurality of bio-sensors 204, a plurality of pressure sensors 206, a communication device 208 associated with a user 202 and the secondary server 108. The user 202 may be an individual or a patient receiving medical care from the health care institution. The user 202 may be suffering from any pain. The communication device 208 runs a pain monitoring application for monitoring the pain of the user 202. Examples of the communication device may include a laptop, a desktop computer, a personal digital assistant and the like.

Further, the user 202 is associated with the plurality of bio-sensors 204. The plurality of bio-sensors includes a PPG sensor, an accelerometer, a respiration monitor, ECG sensor, EEG sensor, EMG sensor, EOG sensor, BP sensor, Glucose sensor, GSR (EDA) sensor, temperature sensor, hydration sensor, and the like. In addition, the plurality of bio-sensors 204 fetches bio-markers associated with the user 202 including heart rate (HR), blood pressure (BP), respiratory rate, skin conductance and the like. The plurality of pressure sensors 206 determines sensitivity of the pain by pressurizing areas of patient's body (body of the user 202) at which the pain is to be diagnosed and recording the pressure level at which the pain is induced in the patient's body.

The plurality of bio-sensors 204 and the plurality of pressure sensors 206 are associated with the communication device 208. The communication device 208 generates the pain profile for the user 202. The pain profile depicts the area and intensity of the pain experienced by the user 202. The intensity of pain is assessed using one or more pain measurement scales. The one or more pain measurement scales include a neonatal pain agitation and sedation scale (N-PASS), a pain assessment tool (PAT), a bernese pain scale for one or more neonates (BPSN), a wong-baker scale, a visual analog scale (VAS), a face, legs, activity, crying, and consolability (FLACC) scale, a Visual Analog Scale (VAS), a Verbal Numeric Rating Scale (VNRS), a Brief Pain inventory (BPI), a behavioral pain scale (BPS), a descriptor differential scale (DDS), a dolorimeter pain index (DPI), a neck pain and disability scale and a Visual Descriptive System (VDS) and the like. Further, the communication device 208 is associated with the secondary server 108. The secondary server 108 includes the second pre-defined database that stores the pain profile of the user 202 along with the demographic information of the user 202. The demographic information includes name, age, gender and the like.

It may be noted that in FIG. 2, the user 202 is associated with the communication device 208 for generating the pain profile of the user 202; however those skilled in the art would appreciate that more communication devices may be utilized for generating the pain profile of more number of users. It may be also noted that in FIG. 2, the secondary server 108 stores the generated pain profile of the user 202; however those skilled in the art would appreciate that the secondary server 108 stores pain profiles of more than one user.

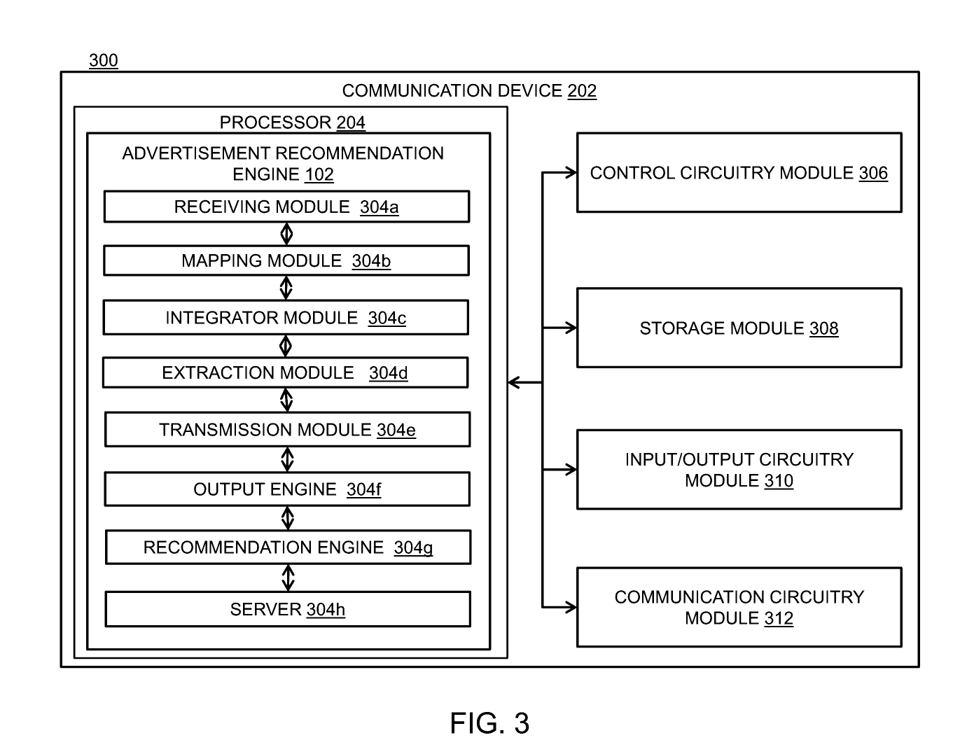

FIG. 3 illustrates a system 300 showing a block diagram of the communication device 302, in accordance with various embodiments of the present disclosure. It may be noted that to explain the system elements of the FIG. 3, references will be made to the system elements of FIG. 1 and FIG. 2. The communication device 302 includes a processor 304, a control circuitry module 306, a storage module 308, an input/output circuitry module 310 and a communication circuitry module 312. Further, the processer 304 includes a receiving module 304a, a mapping module 304b, an integrator module 304c, an extraction module 304d, a generating module 304e, a transmission module 304f, a recommendation engine 304g and a server 304h. The above stated components of the processor 304 enable the working of the advertisement recommendation engine 102 for enabling the automatic advertisement recommendation of the one or more products.

The receiving module 304a receives the one or more attributes of the first set of attributes of the one or more products corresponding to the one or more users from the first pre-defined database of the primary server 104. The first set of attributes includes age group for which the corresponding one or more products are made, gender to which the corresponding one or more products are suitable, pain relieving area, or any other attribute for which the corresponding product is made (as described in the detailed description of FIG. 1).

The mapping module 304b maps the one or more received attributes of the first set of attributes of the one or more products corresponding to the one or more users with the one or more attributes of the second set of attributes stored on the third party database of the third party server 106. The second set of attributes includes name, age, gender, address, contact number and the like. Further, the mapping module 304b performs mapping by identifying the one or more attributes of the second set of attributes which are identical to the one or more attributes of the first set of attributes.

For example, a product X is made for one or more users including males belonging to an age group of 20-30 years having stomach ache, a product Y is made for one or more users belonging to an age group of 25-40 having skin disorder and a product Z is made for one or more users including children below the age of 10 having scars on the body. The receiving module 304a receives attributes of the products X, Y and Z from the primary server 104. The mapping module 304b maps the attributes of the products X, Y and Z with the attributes stored in the third party database of the third party server 106. The mapping in this case may, for example, result in a group of users A include males belonging to an age group of 20-30 years, a group of users B belonging to an age group of 25-40 and a group of users C including children below the age of 10.

Going further, the integrator engine 304c integrates the one or more mapped attributes of the second set of attributes with the one or more attributes of the third set of attributes stored in the secondary server 108. The third set of attributes include but may not be limited to the name, the age, the gender, the pain profiles and the previously recommended one or more products (as described in the detailed description of FIG. 1).

In an embodiment of the present disclosure, the one or more users undergo pain assessment for the monitoring of the intensity of the pain experienced by the one or more users in the health care institution (as elaborated with the detailed description of FIG. 2).

The extraction module 304d extracts the probable group of users of the one or more users based on the integration of the one or more mapped attributes of the second set of attributes with the one or more attributes of the third set of attributes. The generating module 304e generates the ID for each of the one or more users of the extracted probable group of users. In an embodiment of the present disclosure, the generated ID can be an e-mail address, a phone number or any other ID associated with the one or more users. The transmission module 304f transmits each of the generated ID associated with the one or more users to the product based company. The product based company receives each of the transmitted ID associated with the one or more users through the communication network.

The recommendation engine 304g automatically recommends the one or more products to each of the ID associated with the one or more users through one or more advertisements. The one or more users receive the one or more advertisements through e-mails, messages or any other medium capable of providing the advertisement to the one or more users. The server 304h stores data associated with each operation performed by the advertisement recommendation engine 102.

Continuing with the above stated example, the group of users A, the group of users B and the group of users C are integrated with one or more users who are/were undergoing treatment for their corresponding diseases. The integration results in one or more users from the group of users A who were diagnosed with the stomach ache, one or more users from the group of users B who were diagnosed with the skin disorder and one or more users from the group of users C who were diagnosed with the scars on their bodies. The IDs of each of the integrated one or more users belonging to each of the corresponding group of users A, B and C are generated and recommended the product X, the product Y and the product Z respectively.

In an embodiment of the present disclosure, the advertisement recommendation engine 102 allows one or more hospitals to recommend home care services to the one or more users. In another embodiment of the present disclosure, the one or more hospitals utilize information obtained from the one or more users corresponding to reduction in pain for the one or more users during the one or more treatments received by the one or more users. The information is received based on consent and permission from the one or more users.

In an embodiment of the present disclosure, the advertisement recommendation engine 102 recommends one or more health care providers to the one or more users to choose. The recommendation of the one or more health care providers is based on collection of a data corresponding to pain reduction. The pain reduction data is collected through the plurality of bio-sensors 204 and the plurality of pressure sensors 206. In an embodiment of the present disclosure, the plurality of bio-sensors 204 and the plurality of pressure sensors 206 upload the pain reduction data onto a server or database of the one or more hospitals. The one or more hospitals utilize the pain reduction data for providing the one or more users with a data corresponding to service provided by the one or more health care providers. In an embodiment of the present disclosure, the one or more users have a provision of choosing the one or more treatment methods.

It may be noted that in FIG. 3, various modules of the advertisement recommendation engine 102 are shown that illustrates the working of the advertisement recommendation engine 102; however those skilled in the art would appreciate that the advertisement recommendation engine 102 may have more number of modules that could illustrate overall functioning of the advertisement recommendation engine 102. It may also be noted that in FIG. 3, the extraction module 304d extracts the probable group of users; however those skilled in the art would appreciate that the extraction module 304d may extract more number of probable groups of users.

Going further, the communication device 302 includes any suitable type of portable electronic device. Examples of the communication device 302 include but may not be limited to a personal e-mail device (e.g., a Blackberry™ made available by Research in Motion of Waterloo, Ontario), a personal data assistant (“PDA”), a cellular telephone, a Smartphone, a handheld gaming device, a digital camera, the laptop computer, and a tablet computer. In another embodiment of the present disclosure, the communication device 302 can be a desktop computer.

From the perspective of this disclosure, the control circuitry module 306 includes any processing circuitry or processor operative to control the operations and performance of the communication device 302. For example, the control circuitry module 306 may be used to run operating system applications, firmware applications, media playback applications, media editing applications, or any other application. In an embodiment, the control circuitry module 306 drives a display and process inputs received from a user interface.

From the perspective of this disclosure, the storage module 308 includes one or more storage mediums including a hard-drive, solid state drive, flash memory, permanent memory such as ROM, any other suitable type of storage component, or any combination thereof. The storage module 308 may store, for example, media data (e.g., music and video files), application data (e.g., for implementing functions on the communication device 302).

From the perspective of this disclosure, the input/output circuitry module 310 may be operative to convert (and encode/decode, if necessary) analog signals and other signals into digital data. In an embodiment, the input/output circuitry module 310 may also convert the digital data into any other type of signal and vice-versa. For example, the input/output circuitry module 310 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 306, the storage module 308 or any other component of the communication device 302.

It may be noted that the input/output circuitry module 310 is illustrated in FIG. 3 as a single component of the communication device 302; however those skilled in the art would appreciate that several instances of the input/output circuitry module 310 may be included in the communication device 302.

The communication device 302 may include any suitable interface or component for allowing the user 102 to provide inputs to the input/output circuitry module 310. The communication device 302 may include any suitable input mechanism. Examples of the input mechanism include but may not be limited to a button, keypad, dial, a click wheel, and a touch screen. In an embodiment, the communication device 302 may include a capacitive sensing mechanism, or a multi-touch capacitive sensing mechanism.

In an embodiment, the communication device 302 may include specialized output circuitry associated with output devices such as, for example, one or more audio outputs. The audio output may include one or more speakers built into the communication device 302, or an audio component that may be remotely coupled to the communication device 302.

The one or more speakers can be mono speakers, stereo speakers, or a combination of both. The audio component can be a headset, headphones or ear buds that may be coupled to the communication device 302 with a wire or wirelessly.

In an embodiment, the input/output circuitry module 310 may include display circuitry for providing a display visible to the user 102. For example, the display circuitry may include a screen (e.g., an LCD screen) that is incorporated in the communication device 302.

The display circuitry may include a movable display or a projecting system for providing a display of content on a surface remote from the communication device 302 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 306. Alternatively, the display circuitry may be operative to provide instructions to a remote display.

In addition, the communication device 302 includes the communication circuitry module 312. The communication circuitry module 312 may include any suitable communication circuitry operative to connect to a communication network and to transmit communications (e.g., voice or data) from the communication device 302 to other devices within the communications network. The communication circuitry module 312 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communication circuitry module 312 may be operative to create a communications network using any suitable communications protocol. For example, the communication circuitry module 312 may create a short-range communication network using a short-range communications protocol to connect to other devices. For example, the communication circuitry module 312 may be operative to create a local communication network using the Bluetooth,® protocol to couple the communication device 302 with a Bluetooth,® headset.

It may be noted that the computing device is shown to have only one communication operation; however, those skilled in the art would appreciate that the communication device 302 may include one more instances of the communication circuitry module 312 for simultaneously performing several communication operations using different communication networks. For example, the communication device 302 may include a first instance of the communication circuitry module 312 for communicating over a cellular network, and a second instance of the communication circuitry module 312 for communicating over Wi-Fi or using Bluetooth®.

In an embodiment, the same instance of the communication circuitry module 312 may be operative to provide for communications over several communication networks. In an embodiment, the communication device 302 may be coupled a host device for data transfers, synching the communication device 302, software or firmware updates, providing performance information to a remote source (e.g., providing riding characteristics to a remote server) or performing any other suitable operation that may require the communication device 302 to be coupled to a host device. Several computing devices may be coupled to a single host device using the host device as a server. Alternatively or additionally, the communication device 302 may be coupled to the several host devices (e.g., for each of the plurality of the host devices to serve as a backup for data stored in the communication device 302).

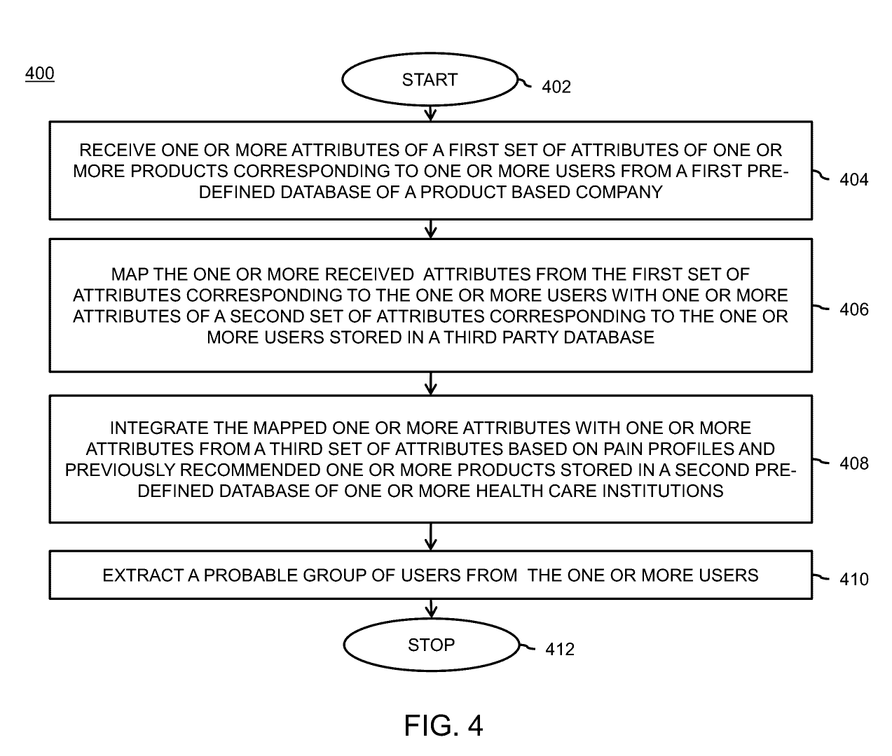

FIG. 4 illustrates a flowchart 400 for enabling the automatic advertisement recommendation of the one or more products, in accordance with various embodiments of the present disclosure. The flow chart 400 initiates at step 402. Following step 402, at step 404, the receiving module 304a receives the one or more attributes of the first set of attributes of the one or more products corresponding to the one or more users from the first pre-defined database of the product based company. At step 406, the mapping module 304b maps the one or more received attributes from the first set of attributes corresponding to the one or more users with the one or more attributes of the second set of attributes corresponding to the one or more users stored in the third party database of the third party server 106. At step 408, the integrator engine 304c integrates the one or more mapped attributes with the one or more attributes from the third set of attributes based on the pain profiles and the previously recommended one or more products stored in the second pre-defined database. At step 410, the extraction module 304d extracts the probable group of users from the one or more users. The probable group of users is extracted based on the ID of each of the one or more users and the ID generated is based on the integrating. The flowchart 400 terminates at step 412.

It may be noted that the flowchart 400 is explained to have above stated process steps; however those skilled in the art would appreciate that the flowchart 400 may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method for enabling automatic advertisement recommendation of one or more products to corresponding one or more users, the computer-implemented method comprising:
receiving, with a processor, one or more attributes of a first set of attributes of the one or more products corresponding to the one or more users from a first pre-defined database of one or more product based companies;
mapping, with the processor, the one or more received attributes of the first set of attributes with one or more attributes of a second set of attributes corresponding to the one or more users stored in a third party database;
integrating, with the processor, the one or more mapped attributes with one or more attributes of a third set of attributes based on pain profiles and previously recommended one or more products stored in a second pre-defined database; and
extracting, with the processor, a probable group of users from the one or more users, wherein the probable group of users being extracted based on an ID of each of the one or more users, and wherein each of the ID being generated based on the integrating.

2. The computer-implemented method as recited in claim 1, further comprising transmitting, with the processor, each of the ID to the corresponding one or more product based companies.

3. The computer-implemented method as recited in claim 1, further comprising recommending, with the processor, one or more advertisements of each of the one or more products to each of the ID corresponding to each user in the probable group of users.

4. The computer-implemented method as recited in claim 1, wherein the one or more attributes of the first set of attributes comprises at least one of age, gender, pain profile and pain relieving area.

5. The computer-implemented method as recited in claim 1, wherein the third party database comprises databases of at least one of advertising agencies, third party advertising exchanges, online publishers, sponsors, social networking platforms and search engines.

6. The computer-implemented method as recited in claim 1, wherein the second set of attributes comprises at least one of name, age, gender and address.

7. The computer-implemented method as recited in claim 1, wherein the third set of attributes comprises at least one of name, age, gender, the pain profiles and the previously recommended one or more products.

8. A computer program product comprising a non-transitory computer readable medium storing a computer readable program, wherein the computer readable program when executed on a computer causes the computer to perform steps comprising:
receiving one or more attributes of a first set of attributes of one or more products corresponding to one or more users from a first pre-defined database of one or more product based companies;
mapping the one or more received attributes of the first set of attributes with one or more attributes of a second set of attributes corresponding to the one or more users stored in a third party database;
integrating the one or more mapped attributes with one or more attributes of a third set of attributes based on pain profiles and previously recommended one or more products stored in a second pre-defined database; and
extracting a probable group of users from the one or more users, wherein the probable group of users being extracted based on an ID of each of the one or more users, and wherein each of the ID being generated based on the integrating.

9. The computer program product as recited in claim 8, wherein the computer readable program when executed on the computer causes the computer to perform a further step of transmitting each of the ID to the one or more product based companies.

10. The computer program product as recited in claim 8, wherein the computer readable program when executed on the computer causes the computer to perform a further step of recommending one or more advertisements of each of the one or more products to each of the ID corresponding to each user of the probable group of users.

11. The computer program product as recited in claim 8, wherein the third party database comprises databases of at least one of advertising agencies, third party advertising exchange, online publishers, sponsors, social networking platform, and search engines.

12. The computer program product as recited in claim 8, wherein the third set of attributes comprises at least one of name, age, gender, the pain profiles and the previously recommended one or more products.

13. A system for enabling automatic advertisement recommendation of one or more products to corresponding one or more users, the system comprising:
a receiving module in a processor, the receiving module being configured to receive one or more attributes of a first set of attributes of the one or more products corresponding to one or more users from a first pre-defined database of one or more product based companies;
a mapping module in the processor, the mapping module being configured to map the one or more received attributes from the first set of attributes with one or more attributes of a second set of attributes corresponding to the one or more users stored in a third party database;
an integrator engine in the processor, the integrator engine being configured to integrate the one or more mapped attributes with one or more attributes from a third set of attributes based on pain profiles and previously recommended one or more products stored in a second pre-defined database; and
an extraction module in the processor, the extraction module being configured to extract a probable group of users from the one or more users.

14. The system as recited in claim 13, further comprising a generating module in the processor, the generating module being configured to generate an ID for each of the one or more users.

15. The system as recited in claim 13, further comprising a transmission module in the processor, the transmission module being configured to transmit the ID of each user of the probable group of users to the one or more product based companies.

16. The system as recited in claim 13, further comprising a recommendation engine in the processor, the recommendation engine being configured to recommend one or more advertisements of the one or more products to each of the corresponding ID of each of the user of the probable group of users.

17. The system as recited in claim 13, wherein the one or more attributes of the first set of attributes comprises at least one of age, gender, pain profile, and pain relieving area.

18. The system as recited in claim 13, wherein the third party database comprises databases of at least one of advertising agencies, third party advertising exchange, online publishers, sponsors, social networking platform, and search engines.

19. The system as recited in claim 13, wherein the second set of attributes comprises at least one of name, age, gender and address.

20. The system as recited in claim 13, wherein the third set of attributes comprises at least one of name, age, gender, the pain profiles and the previously recommended one or more products.
